(19) United States
(12) Patent Application Publication
(10) Pub. No.: US 2020/0040895 A1
(43) Pub. Date: Feb. 6, 2020

(54) MULTISTAGE POWER SAVING VACUUM DEVICE WITH ROOT VACUUM PUMP IN FIRST STAGE

(71) Applicant: Raymond Zhou Shaw, Shanghai (CN)

(72) Inventor: Raymond Zhou Shaw, Shanghai (CN)

(21) Appl. No.: 16/049,831

(22) Filed: Jul. 31, 2018

(51) Int. Cl. F04C 23/00; F04C 18/12; F04C 28/24; F04C 29/00; F04C 28/08; B01D 53/26

(52) U.S. Cl. CPC F04C 23/003; F04C 18/126; F04C 28/24; F04C 29/0092; F04C 28/08; F04C 2270/19; F04C 2220/10; F04C 2270/18; F04C 2270/42; F04C 2270/44; B01D 53/26

(57) ABSTRACT

A multistage power saving vacuum device with a root vacuum pump in a first stage is used in condenser vacuuming of a fired power plant. A root vacuum pump is used in a first stage and then at least one second stage vacuum pump is used to further process the pumping gas so that the gas vented outside is compressed through multiple stages and thus volume of the gas to be vented out has reduced greatly so as to reduce power consumption. The multistage power saving vacuum device comprises a vacuum inlet gas-driving shut-off valve; a first root vacuum pump; at least one second vacuum pump serially connected to the first root vacuum pump; when there are more than one the second vacuum pumps, all the second vacuum pumps are serially connected. The multistage power saving vacuum device further comprises a last stage vacuum pump and a vapor separator.

### FIELD OF THE INVENTION

The present invention relates to vacuum pump systems, in particular to a multistage power saving vacuum device with a root vacuum pump in a first stage.

### BACKGROUND OF THE INVENTION

In a fired power plant, vacuum of a gas condenser has a great effect to consumption of coals in power generation. For a power generator of 300 to 330 MW, a promotion of 1 Kpa in vacuum level will induce consumption of the coals to be reduced with a rate of 2.6 g/kWh. Current used gas vacuum devices in fired power plant are water jet vacuum pumps, water ring/liquid ring pumps or steam vacuum pumps, in these vacuum pumps, water is used a working medium. Efficiencies of these vacuum pumps are related to temperature and pressures of water. The efficiencies of these vacuum pumps are very low and difficult to be controlled.

For example, operation temperature has a great effect to the quality of a water ring pump, while generally a fired power plant uses nature water sources as cooling water. However, temperature of water source is affected by climates and seasons. When cooling water has higher temperature, the vacuum of a vacuum pump will be destroyed so that efficiency of pumping gas is reduced quickly to 80% to 90% of the original quality, and thus, the operation efficiency is affected greatly. Even when the gas pumping under a predetermined pressure in the inlet of the system is reduced to zero, gas etching will generate, this will destroy the equipments and thus the safety operation will be affected dramatically. Therefore, it is often to use two vacuum pumps to retain the vacuum of the condenser and thus to retain the vacuum efficiency of the whole system, but this cause waste of energy.

To reduce power consumption of condensers, the following ways are adapted.

1. Adding other cooling device so as to reduce temperatures of the operation liquids; however, since a power plant uses circulated water cooling towers, in summer, temperature of circulated water increases so that it cannot effectively reduce operation temperatures. If other cooling devices are used to cool water to a temperature lower than the normal temperature, more energy is necessary.

2. Using a high efficiency two stage water ring pump to replace a single stage water ring pump, but this way only causes efficiency of saving power to increase to a ratio of 20% to 30%. It is a finite value and cannot match the requirement for energy saving.

3. Adding a gas injector to reduce the limitation of extreme pumping pressure of the vacuum pump to the pressure of the condenser, but this way will reduce the gas to be pumped and the power consumption is increased.

4. Using a power saving vacuum device with a gas cooling root pump and a liquid ring pump, but this way needs to return a part of gas to the gas cooling root pump to cool the pump body so that the whole efficiency decreases. Furthermore the gas cooling root pump has a large size and weight with a large power consumption needed, while this is unbeneficial to the operation of the whole system.

Therefore, the present invention is aimed to provide a new multistage power saving vacuum device with a root vacuum pump in a first stage for resolving above mention problem.

### SUMMARY OF THE INVENTION

Therefore, the object of the present invention to resolve above mentioned problem. The present invention provides a multistage power saving vacuum device with a root vacuum pump in a first stage, which is used in condenser vacuuming of a fired power plant. In the present invention, a root vacuum pump which has highest efficiency is used in a first stage and then at least one second stage vacuum pump is used to further process the pumping gas so that the gas vented outside is compressed through multiple stages and thus volume of the gas to be vented out has reduced greatly so as to achieve the object of reduction of power consumption.

To achieve above object, the present invention provides a multistage power saving vacuum device with a root vacuum pump in a first stage, comprising: a vacuum inlet gas-driving shut-off valve (13) for receiving non-condensing gas sucked from a power plant condenser; a first root vacuum pump (1) connected to the vacuum inlet gas-driving shut-off valve and to receive and compress gas outputted from the vacuum inlet gas-driving shut-off valve; at least one second vacuum pump (50) serially connected to the first root vacuum pump for further compressing gas from the first root vacuum pump (1); when there are more than one the second vacuum pumps (50), all the second vacuum pumps are serially connected.

The multistage power saving vacuum device with a root vacuum pump further comprises a last stage vacuum pump (60) connected to the at least one second vacuum pump (50) for further compressing the gas outputted from the at least one second vacuum pump (50); and a vapor separator (10) connected to the last stage vacuum pump (60) for separating vapor and air; wherein the gas is vented out and the vapor is returned to the last stage vacuum pump (60).

In the multistage power saving vacuum device with a root vacuum pump pressures measured by a pressure sensor (11) at the inlet of the first root vacuum pump (1), pressures of the input end of the pre driving two-stage circulated pump (3) which is measured by a pressure sensor (12) at the output end of the at least one second vacuum pump, temperatures measured by a temperature sensor (15) in the first root vacuum pump (1) and a temperature sensor (16) in the at least one vacuum pump (2) are analyzed; and then signals from the analysis are transferred to a first frequency adjustable motor (181) of the first root vacuum pump (1) and a second frequency adjustable motor (191) of the first one second vacuum pump (50) so as to adjust rotation speeds of the first frequency adjustable motor (181) and the second frequency adjustable motor (191) so that the whole system has an optimum and safe operation.

### BRIEF DESCRIPTION OF THE DRAWINGS

FIG. 1 is an assembly view of the components of the present invention, in that a three stage structure is shown.

FIG. 2 is a lateral view of FIG. 1.

FIG. 3 is a rear view of FIG. 1.

FIG. 4 is a block diagram about a three stage structure of the present invention.

FIG. 5 is a block diagram about a four stage structure of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

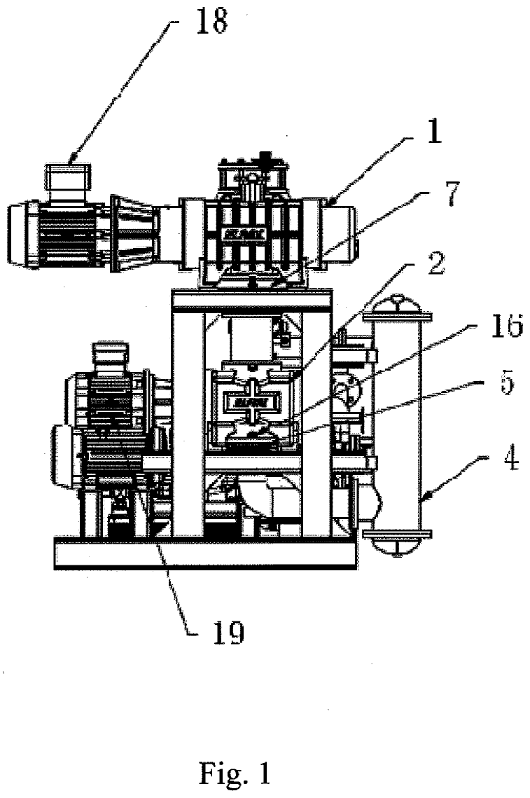

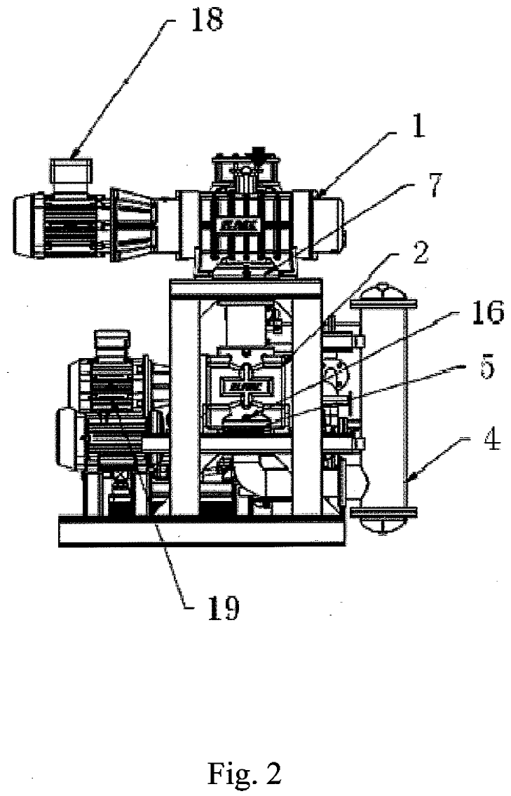

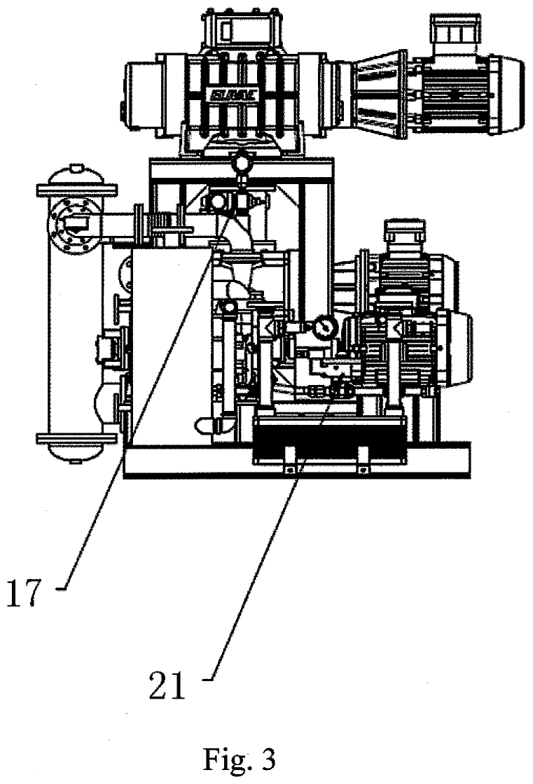

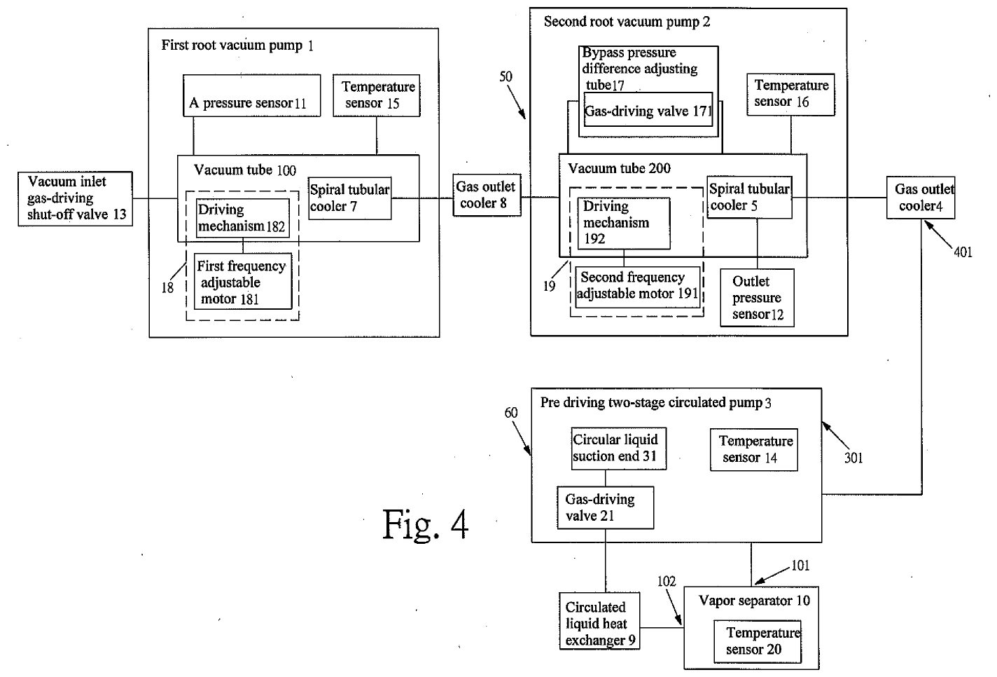

With reference to FIGS. 1 to 5, the structure of the present invention is illustrated. As those shown in FIGS. 1 to 4, in this the present invention, a cooling process of three stages is used as an example for describing the structure of the present invention, but the present invention is not limited to the three stage structure. The structure of the present invention includes the following elements.

A vacuum inlet air-driving shut-off valve 13 serves for receiving non-condensing gas sucked from a power plant condenser (not shown).

A first root vacuum pump 1 is connected to the vacuum inlet air-driving shut-off valve 13 and serves to receive and compress gas outputted from the vacuum inlet air-driving shut-off valve 13. The first root vacuum pump 1 comprises the following elements.

A first vacuum tube 100 is connected to the vacuum inlet air-driving shut-off valve 13. The first vacuum tube 100 receives gas from the vacuum inlet air-driving shut-off valve 13 and then the gas thereinwithin is compressed.

An inlet gas pressure sensor 11 is positioned at an inlet end of the first vacuum tube 100 for detecting gas pressure at the inlet of the first vacuum tube 100.

A first gas driving device 18 serves for driving gas within the first vacuum tube 100. The first gas-driving device 18 includes a first frequency adjustable motor 181 having a variable frequency drive (not shown). The first frequency adjustable motor 181 is at an outer side of the first vacuum tube 100. The frequency of the frequency adjustable motor 181 is adjustable based on requirement of the system. The first gas-driving device 18 further includes a driving mechanism 182 (such as blades). The driving mechanism 182 serves to drive gas within the first vacuum tube 100. This is known in the prior art and thus the details will not be further described herein.

A spiral tubular cooler 7 is positioned in the first vacuum tube 100. The gas is compressed, then cooled by the spiral tubular cooler 7 and then outputted.

A temperature sensor 15 is positioned at an output end of the first vacuum tube 100 for detecting temperature at an outlet end of the first vacuum tube 100.

An gas outlet cooler 8 has an inlet end connected to the spiral tubular cooler 7 for further cooling the gas cooled by the spiral tubular cooler 7.

Non-condensing gas from a power plant is inputted to the first vacuum tube 100 of the first root vacuum pump 1 through the vacuum inlet gas-driving shut-off valve 13. Then the gas is driven by the first gas-driving device 18 and is compressed in the first root vacuum pump 18. During compressing, the spiral tubular cooler 7 cools the compressed gas and then the gas is outputted and is further cooled by the gas outlet cooler 8.

A second root vacuum pump 2 is connected to an output end of the gas outlet cooler 8. The second root vacuum pump 2 serves to receive gas from the first root vacuum pump 18 through the gas outlet cooler 8 and then compresses the gas. The second root vacuum pump 2 includes the following elements.

A second vacuum tube 200 is connected to the gas outlet cooler 8. The gas is compressed in the second vacuum tube 200.

An outlet pressure sensor 12 is positioned at an outlet of the second vacuum tube 200 for detecting gas pressure at the outlet end of the second vacuum tube 200.

A second gas-driving device 19 serves for driving gas within the second vacuum tube 200. The second gas-driving device 19 includes a second frequency adjustable motor 191 having a variable frequency drive (not shown). The second frequency adjustable motor 191 is at an outer side of the second vacuum tube 200. The frequency of the frequency adjustable motor 191 is adjustable based on requirement of the system. The second gas-driving device 19 further includes a second driving mechanism 192 (such as blades). The second driving mechanism 192 serves to drive gas within the second vacuum tube 200. This is known in the prior art and thus the details will not be further described herein.

A second spiral tubular cooler 5 is positioned in the second vacuum tube 200. The gas is compressed, then cooled by the second spiral tubular cooler 5 and then outputted.

A second temperature sensor 16 is positioned at an output of the second vacuum tube 200 for detecting temperature at an outlet end of the second vacuum tube 100.

A bypass pressure difference adjusting tube 17 is connected to the second vacuum tube 200 for adjusting the pressure difference in the second vacuum tube 200. The system opens or closes a gas-driving valve 171 of the bypass pressure difference adjusting tube 17 for adjusting gas pressure difference of the vacuum tube 200.

A second gas outlet cooler 4 has an input end connected to the spiral tubular cooler 5 and further cools gas outputted from the second spiral tubular cooler 5.

Gas outputted from the first gas outlet cooler 8 and the first root vacuum pump 1 is further outputted to the second root vacuum tube 200 of the second root vacuum pump 2. The gas within the second root vacuum tube 200 is driven by the second gas-driving device 19 and is compressed in the second root vacuum pump 2 and is then cooled by the second spiral tubular cooler 5. Next, the gas is outputted to the second gas outlet cooler 4 for being further cooled.

A pre-driving two-stage liquid ring pump 3 has an inlet end 31 which is connected to the output end 401 of the gas outlet cooler 4 for receiving gas outputted from the second root vacuum pump 2 and then compressed the gas and water in the pre-driving two-stage ring pump 3 to form a mixture of gas and vapor. The pre driving two-stage circulated pump 3 includes a second temperature sensor 14 is positioned at an inlet of the pre driving two-stage ring pump 3 for detecting temperatures at the inlet.

A vapor separator 10 has an inlet 101 connected to the pre driving two-stage ring pump 3. The mixture of gas and vapor in the pre driving two-stage ring pump 3 is inputted to the vapor separator 10 for separating the gas from the vapor. The vapor separator 10 includes a temperature sensor 20 at an output end of the vapor separator 10 for detecting the vapor temperature at the output end of the vapor separator 10.

A circulated liquid heat exchanger 9 has an input end connected to the output end 102 of the vapor separator 10. An output end of the circulated liquid heat exchanger 9 is connected to the pre driving two-stage circulated pump 3. The water from the vapor separating from the mixture in the vapor separator 10 is outputted to the circulated liquid heat exchanger 9 for being cooled therein and then returns to the pre driving two-stage circulated pump 3.

The present invention further includes an gas-driving valve 21 which is positioned at the circular liquid suction end 31 of the pre driving two-stage circulated pump 3 for controlling water from the vapor separator 10 to the pre driving two-stage circulated pump 3.

The compressed mixture of gas and vapor in the pre driving two-stage circulated pump 3 is inputted to the vapor separator 10 for separating gas from the vapor. The gas separated is drained out from a top end of the vapor separator 10.

The gas after cooled by the gas outlet cooler 4 flows into the pre driving two-stage circulated pump 3 and then is compressed and mixed to form as the mixture of gas and vapor and then the mixture flows into the vapor separator 10 for separating the gas and vapor. The gas is drained out from the top of the vapor separator 10 and the vapor is cooled by the circulated liquid heat exchanger 9 and then returns to the pre driving two-stage circulated pump 3. When the system is necessary to be actuated or stop and has faults, the gas drive valve 21 of the pre driving two-stage circulated pump 3 will be opened or closed to prevent too much circulated liquid of the vapor separator 10 from flowing into the pre driving two-stage circulated pump 3 to induce water returning back or water overflow.

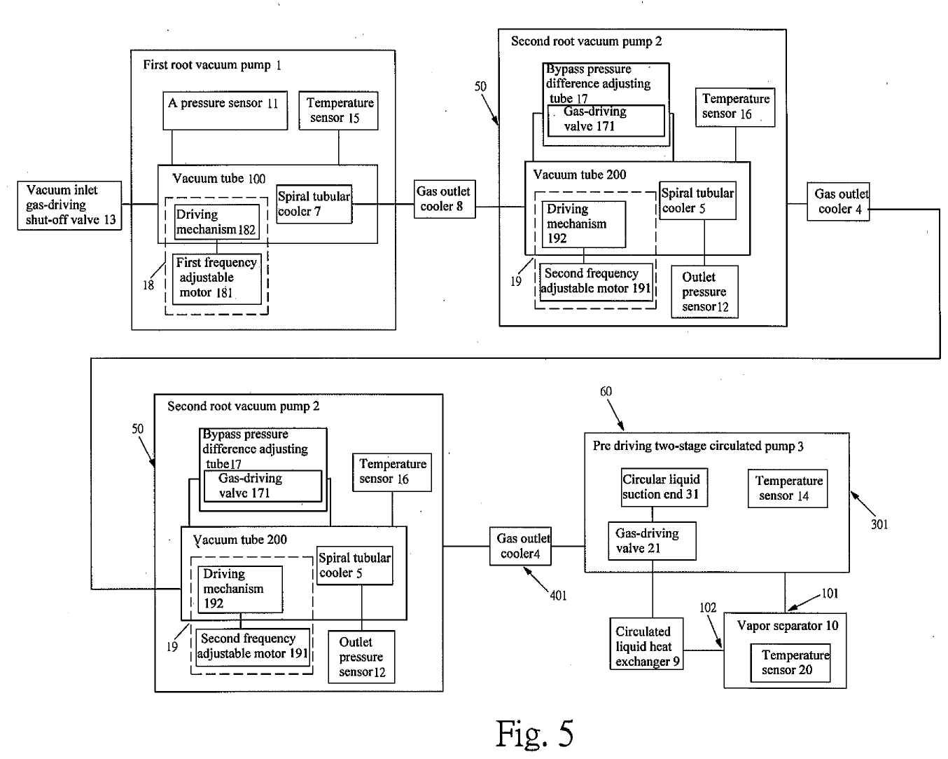

With reference to FIGS. 1 to 3, a three stage structure of the present invention is illustrated. FIG. 5 shows a fourth stage structure according to the present invention. However, in this embodiment, a three stage structure is used as an example for description of the present invention.

In the present invention, the second root vacuum pump 2 may be repeated. As referring to FIG. 5, a fourth stage structure is illustrated. In this structure, two second root vacuum pumps 2 are arranged. Each of the second root vacuum pumps is serially connected with a respective gas outlet cooler 4. The spiral tubular cooler 5 in the former second root vacuum pump 2 is connected to the second vacuum tube 200 in the later second root vacuum pump 2. The spiral tubular cooler 5 in the last second root vacuum pump 2 is connected to the pre driving two-stage circulated pump 3 through a respective gas outlet cooler 4.

In the present invention, the output and input pressures and temperatures are measured for performing a feedback operation so that the efficiency of the system is promoted. In this operation, pressures measured by the pressure sensor 11 at the inlet of the first root vacuum pump 1 and the pressures of the input end of the pre driving two-stage circulated pump 3 which is measured by the pressure sensor 12 at the output end of the second root vacuum pump are analyzed. Furthermore the temperatures measured by the temperature sensor 15 in the first root vacuum pump 1 and the temperature sensor 16 in the second root vacuum pump 2 are transferred for analyzing. Then control signals are transferred to the first frequency adjustable motor 181 and the second frequency adjustable motor 191 so as to adjust rotation speeds of the first frequency adjustable motor 181 and the second frequency adjustable motor 191. Therefore, the whole system has an optimum and safety operation. Furthermore the system can open or close the gas-driving valve 171 of the bypass pressure difference adjusting tube 17 of the second root vacuum pump 2 to adjust the pressure difference within the vacuum tube 200.

By above mentioned structure, when a three stage vacuum system is desired to retain the vacuum in the condenser of a fired power plant, a three stage structure according to the present invention is suitable for this object. Similarly for a fired power plant with lower capacity having a steam vacuum pump, or a centrifugal vacuum pump which retains a very lower vacuum or total pumping gas is low, a two stage root vacuum pump system according to the present invention may be used.

Advantages of the present invention are that in the present invention, when a root vacuum pump (not an gas cooling root pump) is used in the first stage and other pumps, such as root vacuum pumps, or other vacuum pumps are used in the following stages, the power consumption may have a reduction of 80% as compared with other conventional water ring pumps, steam pumps, centrifugal pumps. Thereby, using the root vacuum pumps with other liquid ring pumps or vacuum pumps, the system may have a power saving of 20%-30% as comparing with the original system. Furthermore the area needed to arranging the structure of the present invention is only one fourth of the area used in other conventional water ring pump set or is only 70% of the area used in the gas cooling root vacuum pump. Thereby, the present invention has the advantages of lowest power consumption and smallest area used for the overall equipments. Furthermore since the vacuum for a multiple stage root power saving system is mainly determined by the root vacuum pumps, it is only slightly affected by temperatures. Because the original vacuum system has a larger drainage, it is very possible to further promote the vacuum level of the system, the power saving vacuum system of the present invention is more suitable for improving vacuuming of the gas condense of a fired power plant.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multistage power saving vacuum device with a root vacuum pump in a first stage, comprising:
a vacuum inlet gas-driving shut-off valve (13) for receiving non-condensing gas pumping from a power plant condenser;
a first root vacuum pump (1) connected to the vacuum inlet gas-driving shut-off valve for receiving and compressing the gas outputted from the vacuum inlet gas-driving shut-off valve;
at least one second vacuum pump (50) serially connected to the first root vacuum pump for further compressing the gas from the first root vacuum pump (1); and when there are more than one second vacuum pumps (50), all the second vacuum pumps being serially connected.

2. The multistage power saving vacuum device with a root vacuum pump in a first stage as claimed in claim 1, further comprising:
a last stage vacuum pump (60) connected to the at least one second vacuum pump (50) for further compressing the gas outputted from the at least one second vacuum pump (50); and
a vapor separator (10) connected to the last stage vacuum pump (60) for separating vapor and air; wherein the gas is vented out and the vapor is returned to the last stage vacuum pump (60).

3. The multistage power saving vacuum device with a root vacuum pump in a first stage as claimed in claim 1, wherein the at least one second vacuuming device (50) has only one vacuum pump.

4. The multistage power saving vacuum device with a root vacuum pump in a first stage as claimed in claim 3, wherein the second vacuum pump is a root vacuum pump.

5. The multistage power saving vacuum device with a root vacuum pump in a first stage as claimed in claim 1, wherein the at least one second vacuum pump (5) is two vacuum pumps which are serially connected.

6. The multistage power saving vacuum device with a root vacuum pump in a first stage as claimed in claim 5, wherein each of the vacuum pumps is a root vacuum pumps.

7. The multistage power saving vacuum device with a root vacuum pump in a first stage as claimed in claim 5, wherein one of the vacuum pumps is a root vacuum pumps.

8. The multistage power saving vacuum device with a root vacuum pump in a first stage as claimed in claim 1, wherein a gas valve of each vacuum pump is automatically and intellectually controlled.

9. The multistage power saving vacuum device with a root vacuum pump in a first stage as claimed in claim 1, wherein pressures measured by a pressure sensor (11) at the inlet of the first root vacuum pump (1), pressures of the input end of the pre driving two-stage circulated pump (3) which are measured by a pressure sensor (12) at the output end of the at least one second vacuum pump, temperatures measured by a temperature sensor (15) in the first root vacuum pump (1) and a temperature sensor (16) in the at least one second vacuum pump (50) are analyzed; and then signals from the analysis are transferred to a first frequency adjustable motor (181) of the first root vacuum pump (1) and a second frequency adjustable motor (191) of the first one second vacuum pump (50) so as to adjust rotation speeds of the first frequency adjustable motor (181) and the second frequency adjustable motor (191) so that the whole system has an optimum and safe operation.

10. The multistage power saving vacuum device with a root vacuum pump in a first stage as claimed in claim 7, wherein the second vacuum pump (50) further comprises a second vacuum tube (200); the system can open or close an gas-driving valve (171) of the bypass pressure difference adjusting tube (17) of the second root vacuum pump (2) so as to adjust the pressure difference within the vacuum tube (200).
